(19) United States
(12) Patent Application Publication
(10) Pub. No.: US 2025/0234273 A1
(43) Pub. Date: Jul. 17, 2025

(54) CELL BARRING BASED ON DEVICE CAPABILITY AT A FREQUENCY BAND

(71) Applicant: Nokia Technologies Oy, Espoo (FI)

(72) Inventors: Jussi-Pekka KOSKINEN, Oulu (FI); Samuli Heikki TURTINEN, Oulu (FI); Jakub Janusz BLUSZCZ, Wroclaw (PL)

(21) Appl. No.: 18/956,404

(22) Filed: Nov. 22, 2024

(30) Foreign Application Priority Data
Jan. 15, 2024 (FI) 20245027

(51) Int. Cl. H04W 48/02; H04W 8/22; H04W 36/08

(52) U.S. Cl. CPC H04W 48/02; H04W 8/22; H04W 36/08

(57) ABSTRACT

Various example embodiments relate to cell barring. A method may comprise: determining, by a device, a frequency band of a cell; receiving, by the device, an indication of a barring status of the cell, wherein the barring status is associated with a capability of the device; determining, by the device, the capability of the device at the frequency band of the cell; and determining, by the device, whether the cell is barred for the device based on the barring status and the capability of the device at the frequency band of the cell.

### TECHNICAL FIELD

Various example embodiments generally relate to the field of wireless communication. Some example embodiments relate to barring of cells for reduced capability devices based on their capabilities at a particular frequency band.

### BACKGROUND

In wireless communications, access nodes of a cellular radio network may be configured to provide communication services to devices, such as user equipment (UE), via cells. The cellular radio network may be configured to serve different types of devices, such as for example reduced capability (RedCap) devices, which may be targeted for low cost, low energy consumption, and/or low data rate applications, for example in industrial wireless sensor networks. Cells of the cellular radio network may be barred from access for various reasons. Before attempting to access the network, a UE may be configured to evaluate broadcast information of the cell and determine whether a connection request to the cell is allowed or not.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments of the present disclosure enable to improve cell barring in a cellular communication network. This and other benefits may be achieved by the features of the independent claims. Further example embodiments are provided in the dependent claims, the description, and the drawings.

According to a first aspect, a method is disclosed. The method may comprise: determining, by a device, a frequency band of a cell; receiving, by the device, an indication of a barring status of the cell, wherein the barring status is associated with a capability of the device; determining, by the device, the capability of the device at the frequency band of the cell; and determining, by the device, whether the cell is barred for the device based on the barring status and the capability of the device at the frequency band of the cell.

According to an example embodiment of the first aspect, the indication of the barring status comprises an indication of whether the cell is barred for devices supporting single receiver branch operation or whether the cell is barred for devices supporting dual receiver branch operation, and the capability of the device comprises a capability to support the single receiver branch operation or the dual receiver branch operation at the frequency band of the cell.

According to an example embodiment of the first aspect, the method comprises: determining, by the device, the capability to support the single receiver branch operation or the dual receiver branch operation based on a maximum number of downlink multiple input multiple output (MIMO) layers supported by the device at the frequency band of the cell.

According to an example embodiment of the first aspect, the method comprises: determining, by the device, that the device has the capability to support the single receiver branch operation, based on absence of an indication of the maximum number of downlink MIMO layers in user equipment capability information of the device; or determining, by the device, that the device has the capability to support the dual receiver branch operation, in response to determining the indication of the maximum number of downlink MIMO layers in the user equipment capability information of the device to indicate two downlink MIMO layers; or determining, by the device, that the device has the capability to support the dual receiver branch operation, in response to determining that the frequency band of the cell belongs to a Frequency Range 2.

According to an example embodiment of the first aspect, the method comprises: determining, by the device, that the cell is barred for the device, in response determining that the barring status is indicative of the cell being barred for devices supporting the single receiver branch operation and that the device supports the single receiver branch operation at the frequency band of the cell; or determining, by the device, that the cell is barred for the device, in response determining that the barring status is indicative of the cell being barred for devices supporting the dual receiver branch operation and that the device supports the dual receiver branch operation at the frequency band of the cell.

According to an example embodiment of the first aspect, the method comprises: determining, by the device, that the cell is not barred for the device, in response to determining that the barring status is indicative of the cell not being barred for devices supporting the single receiver branch operation and that the device supports the single receiver branch operation at the frequency band of the cell; or determining, by the device, the cell is not barred for the device, in response to determining that the barring status is indicative of the cell not being barred for devices supporting the dual receiver branch operation and that the device supports the dual receiver branch operation at the frequency band of the cell.

According to an example embodiment of the first aspect, the method comprises: determining, by the device, to refrain from selecting or reselecting the cell, in response to determining that the cell is barred for the device; or determining, by the device, to select or reselect the cell, based on determining that the cell is not barred for the device.

According to an example embodiment of the first aspect, the indication of the barring status is targeted to devices belonging to a category of reduced capability devices.

According to an example embodiment of the first aspect, the capability of the device comprises the device belonging to a category of reduced capability devices.

According to an example embodiment of the first aspect, the device belongs to a category of reduced capability devices.

According to an example embodiment of the first aspect, the category of reduced capability devices comprises a category of RedCap devices or a category of eRedCap devices.

According to an example embodiment of the first aspect, the indication of the barring status is associated with a current frequency band of the cell, or the capability of the device is related to receiver operation of the device.

According to an example embodiment of the first aspect, the method comprises: receiving, by the device, the indication of the barring status from the cell via a system information block message.

According to an example embodiment of the first aspect, the method comprises: determining, by the device, the frequency band of the cell based on a frequency band list received from the cell via the system information block message.

According to an example embodiment of the first aspect, the device is not allowed to access the cell when the cell is barred for the device.

According to a second aspect, a method is disclosed. The method may comprise: transmitting, to a device, an indication of a barring status of a cell, wherein the barring status is associated with a capability of the device, wherein the indication of the barring status comprises an indication of whether the cell is barred for devices supporting single receiver branch operation or whether the cell is barred for devices supporting dual receiver branch operation, and wherein the capability of the device comprises a capability to support the single receiver branch operation or the dual receiver branch operation at the frequency band of the cell.

According to an example embodiment of the second aspect, the indication of the barring status is targeted to devices belonging to a category of reduced capability devices.

According to an example embodiment of the second aspect, the capability of the device comprises the device belonging to a category of reduced capability devices.

According to an example embodiment of the second aspect, the device belongs to a category of reduced capability devices.

According to an example embodiment of the second aspect, the category of reduced capability devices comprises a category of RedCap devices or a category of eRedCap devices.

According to an example embodiment of the second aspect, the indication of the barring status is associated with a current frequency band of the cell, or the capability of the device is related to receiver operation of the device.

According to a third aspect, a device is disclosed. The device may comprise: at least one processor; and at least one memory storing instructions that, when executed by the at least one processor, cause the device at least to: determine a frequency band of a cell; receive an indication of a barring status of the cell, wherein the barring status is associated with a capability of the device; determine the capability of the device at the frequency band of the cell; and determine whether the cell is barred for the device based on the barring status and the capability of the device at the frequency band of the cell.

According to an example embodiment of the third aspect, the indication of the barring status comprises an indication of whether the cell is barred for devices supporting single receiver branch operation or whether the cell is barred for devices supporting dual receiver branch operation, and the capability of the device comprises a capability to support the single receiver branch operation or the dual receiver branch operation at the frequency band of the cell.

According to an example embodiment of the third aspect, the instructions are configured to, when executed by the at least one processor, cause the device to: determine the capability to support the single receiver branch operation or the dual receiver branch operation based on a maximum number of downlink multiple input multiple output (MIMO) layers supported by the device at the frequency band of the cell.

According to an example embodiment of the third aspect, the instructions are configured to, when executed by the at least one processor, cause the device to: determine that the device has the capability to support the single receiver branch operation, based on absence of an indication of the maximum number of downlink MIMO layers in user equipment capability information of the device; or determine that the device has the capability to support the dual receiver branch operation, in response to determining the indication of the maximum number of downlink MIMO layers in the user equipment capability information of the device to indicate two downlink MIMO layers; or determine that the device has the capability to support the dual receiver branch operation, in response to determining that the frequency band of the cell belongs to a Frequency Range 2.

According to an example embodiment of the third aspect, the instructions are configured to, when executed by the at least one processor, cause the device to: determine that the cell is barred for the device, in response determining that the barring status is indicative of the cell being barred for devices supporting the single receiver branch operation and that the device supports the single receiver branch operation at the frequency band of the cell; or determine that the cell is barred for the device, in response determining that the barring status is indicative of the cell being barred for devices supporting the dual receiver branch operation and that the device supports the dual receiver branch operation at the frequency band of the cell.

According to an example embodiment of the third aspect, the instructions are configured to, when executed by the at least one processor, cause the device to: determine that the cell is not barred for the device, in response to determining that the barring status is indicative of the cell not being barred for devices supporting the single receiver branch operation and that the device supports the single receiver branch operation at the frequency band of the cell; or determine that the cell is not barred for the device, in response to determining that the barring status is indicative of the cell not being barred for devices supporting the dual receiver branch operation and that the device supports the dual receiver branch operation at the frequency band of the cell.

According to an example embodiment of the third aspect, the instructions are configured to, when executed by the at least one processor, cause the device to: determine to refrain from selecting or reselecting the cell, in response to determining that the cell is barred for the device; or determine to select or reselect the cell, based on determining that the cell is not barred for the device.

According to an example embodiment of the third aspect, the indication of the barring status is targeted to devices belonging to a category of reduced capability devices.

According to an example embodiment of the third aspect, the capability of the device comprises the device belonging to a category of reduced capability devices.

According to an example embodiment of the third aspect, the device belongs to a category of reduced capability devices.

According to an example embodiment of the third aspect, the category of reduced capability devices comprises a category of RedCap devices or a category of eRedCap devices.

According to an example embodiment of the third aspect, the indication of the barring status is associated with a current frequency band of the cell, or the capability of the device is related to receiver operation of the device.

According to an example embodiment of the third aspect, the instructions are configured to, when executed by the at least one processor, cause the device to: receive the indication of the barring status from the cell via a system information block message.

According to an example embodiment of the third aspect, the instructions are configured to, when executed by the at least one processor, cause the device to: determine the frequency band of the cell based on a frequency band list received from the cell via the system information block message.

According to an example embodiment of the third aspect, the device is not allowed to access the cell when the cell is barred for the device.

According to a fourth aspect, an access node is disclosed. The access node may comprise: at least one processor; and at least one memory storing instructions that, when executed by the at least one processor, cause the access node at least to: transmit, to a device, an indication of a barring status of a cell, wherein the barring status is associated with a capability of the device, wherein the indication of the barring status comprises an indication of whether the cell is barred for devices supporting single receiver branch operation or whether the cell is barred for devices supporting dual receiver branch operation, and wherein the capability of the device comprises a capability to support the single receiver branch operation or the dual receiver branch operation at the frequency band of the cell.

According to an example embodiment of the fourth aspect, the indication of the barring status is targeted to devices belonging to a category of reduced capability devices.

According to an example embodiment of the fourth aspect, the capability of the device comprises the device belonging to a category of reduced capability devices.

According to an example embodiment of the fourth aspect, the device belongs to a category of reduced capability devices.

According to an example embodiment of the fourth aspect, the category of reduced capability devices comprises a category of RedCap devices or a category of eRedCap devices.

According to an example embodiment of the fourth aspect, the indication of the barring status is associated with a current frequency band of the cell, or the capability of the device is related to receiver operation of the device.

According to a fifth aspect, a device is disclosed. The device may comprise: means for determining a frequency band of a cell; means for receiving an indication of a barring status of the cell, wherein the barring status is associated with a capability of the device; means for determining the capability of the device at the frequency band of the cell; and means for determining whether the cell is barred for the device based on the barring status and the capability of the device at the frequency band of the cell. The device may comprise means for performing any example embodiment of the method of the first aspect.

According to a sixth aspect, an access node is disclosed. The access node may comprise: means for transmitting, to a device, an indication of a barring status of a cell, wherein the barring status is associated with a capability of the device, wherein the indication of the barring status comprises an indication of whether the cell is barred for devices supporting single receiver branch operation or whether the cell is barred for devices supporting dual receiver branch operation, and wherein the capability of the device comprises a capability to support the single receiver branch operation or the dual receiver branch operation at the frequency band of the cell.

According to a seventh aspect, a computer program, a computer program product, or a (non-transitory) computer-readable medium is disclosed. The computer program, computer program product, or (non-transitory) computer-readable medium may comprise instructions, which when executed by an apparatus, cause the apparatus at least to perform the method according to the first or second aspect, or any example embodiment(s) thereof.

Example embodiments of the present disclosure can thus provide apparatuses, methods, computer programs, computer program products, or computer readable media for improving various aspects of wireless tethering. Any example embodiment may be combined with one or more other example embodiments. These and other aspects of the present disclosure will be apparent from the example embodiment(s) described below. According to some aspects, there is provided the subject matter of the independent claims. Some further aspects are defined in the dependent claims.

### DESCRIPTION OF THE DRAWINGS

The accompanying drawings, which are included to provide a further understanding of the example embodiments and constitute a part of this specification, illustrate example embodiments and, together with the description, help to explain the example embodiments. In the drawings:

FIG. 1 illustrates an example of a communication network;

FIG. 2 illustrates an example of an apparatus configured to practice one or more example embodiments;

FIG. 3 illustrates an example of signalling and operations for cell barring based on receiver capability of a user equipment (UE) on a certain frequency band;

FIG. 4 illustrates an example of a method for cell barring; and

FIG. 5 illustrates an example con a method for controlling cell barring.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

One aim for cellular communication networks is to accelerate industrial transformation and digitalization, for example in order to improve flexibility, enhance productivity and efficiency, reduce maintenance, or improve operational safety. For example, industrial sensors may be exploited for realizing such a vision. In addition to industrial automation and digitalization scenarios, industrial sensors may be also used in general environmental monitoring use cases, for example for monitoring infrastructure (e.g., buildings, bridges, or water dams) or monitoring for natural disasters (e.g., wild fire, flood, tsunami, or earthquake).

Another class of use cases for cellular connectivity is the smart city vertical, which may include data collection and processing to enable more efficient monitoring and control of city resources, or to provide services to city residents. Surveillance cameras are an example of a building block of a smart city, but they may be relevant also for factories and industries.

Furthermore, corresponding use cases may be provided for wearables such as smart watches, eHealth related devices, or medical monitoring devices. These use cases may come with different design considerations and have different preferences requirements in terms of form factor, UE complexity, or and energy efficiency, for example when compared to enhanced mobile broadband (eMBB) devices.

The support of industrial sensors, video surveillance, and wearables may be considered as one target for enabling reduced capability (RedCap) access to cellular communication networks, such as for example specified in the 3GPP (3rd Generation Partnership Project) 5G New Radio (NR) standard. A RedCap device may therefore comprise a 3GPP RedCap device. One target of such work may be to establish a framework for enabling implementation of reduced capability devices suitable for a range of use cases, including, for example, the industrial sensors, video surveillance, and wearables use cases, with requirements on low UE complexity, low UE power consumption, or both. To expand the market for RedCap use cases with relatively low cost, low energy consumption, or low data rate requirements, e.g., industrial wireless sensor network use cases, further complexity reduction enhancements may be therefore considered. For example, it may be desired to provide support for low-tier devices, e.g., between capabilities low-power wide-area (LPWA) UEs and the capabilities of RedCap UEs. A target for supported peak data rate may be for example 10 Mbps. A RedCap device may be a category of devices which have at least one reduced capability when compared to another category of devices (e.g., non-RedCap devices). Capabilities of devices belonging to the RedCap category or other categories may be for example defined in standards.

As described herein, the desired enhancements may be implemented while maintaining integrity of the RedCap ecosystem and utilizing the benefit of economies of scale. One target may be to consider enhancements applicable to the RedCap framework, including principles of network awareness of device capabilities.

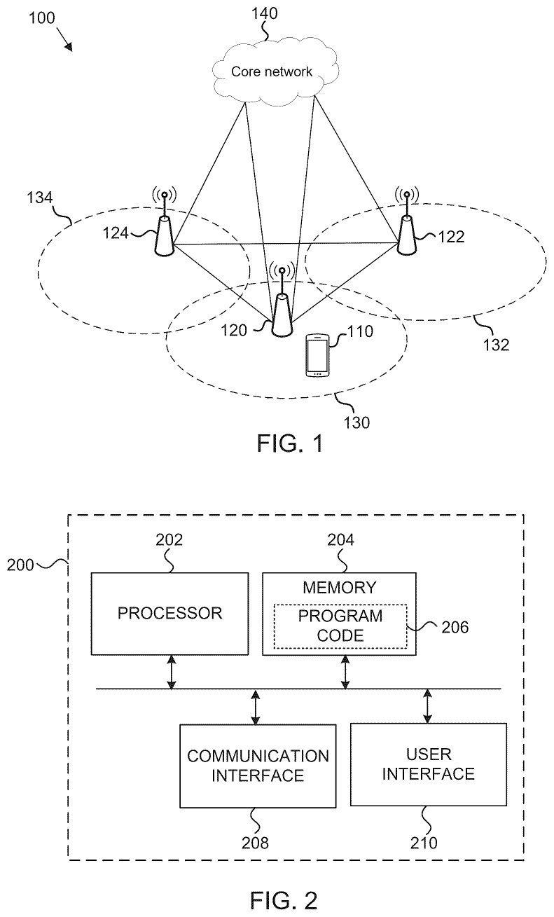

FIG. 1 illustrates an example of a communication network. Communication network 100 may comprise one or more access nodes 120, 122, 124. Access node(s) 120, 122, 124 may be part of a radio access network (RAN) configured to enable a device, represented throughout the description by UE 110, to access communication services provided by core network 140. In connection with communication network 100, access node(s) 120, 122, 124 and core network 140 may be collectively referred to as ‘network’. UE 110 may be referred to as a user device, a terminal apparatus, a terminal device, a mobile device, or the like. UE 110 may be configured to communicate with access node(s) 120, 122, 124 over a radio interface, which may be also referred to as an air interface. Access nodes 120, 122, 124 may be also referred to as network devices. A terminal device may comprise a device to which a connection from a communication network is terminated.

The radio interface may be configured for example based on the 5G NR (New Radio) standard defined by the 3rd Generation Partnership Project (3GPP), or any future standard or technology (e.g., 6G). Access nodes 120, 122, 124 may for example comprise 5th generation access nodes (gNB). Transmission by an access node to UE 110 may be called downlink (DL) transmission. Transmission by UE 110 to an access node may be called uplink (UL) transmission. UE 110 may be therefore configured to operate as a transmitter for uplink transmissions and as a receiver for downlink transmissions. Access node(s) 120, 122, 124 may be configured to operate as a receiver for uplink transmissions and as a transmitter for downlink transmissions. Communication network 100 may comprise a wireless communication network or a mobile communication network, such as for example a cellular communication network. UE 110 may be configured to communicate with access node(s) 120, 122, 124 using one or more logical channels and/or physical channels, for example a control channel such as the physical downlink control channel (PDCCH) or data channels such as the physical downlink shared channel (PDSCH) or the physical uplink shared channel (PUSCH). Shared data channels, e.g., PDSCH and PUSCH, may be shared by multiple UEs. An access node may be also referred to as an access point or a base station.

Core network 140 may be implemented with various network functions (NF), including, for example, one or more user plane functions (UPF) and one or more access and mobility management functions (AMF). A UPF may be configured to handle user data part of a communication session. A UPF may thus provide an interconnect point between the radio access network and a data network configured to provide application services to UE 110 via core network 140 and the radio access network. For example, a UPF may be configured to handle encapsulation and decapsulation of user plane protocol(s), such as the GPRS (general packet radio service) tunnelling protocol for the user plane (GTP-U). An AMF may be configured to receive connection and session request related data from UE 110 (via an access node). An AMF may be configured to control connection and mobility management in communication network 100.

An access node 120, 122, 124 may be configured to communicate with UEs via one or more cells. For example, access node 120 may be configured to serve one or more UEs at cell 130. Access node 122 may be configured to serve UEs at cell 132. Access node 124 may be configured to serve UEs at cell 134. A cell may be configured to serve UEs at a certain geographical area at a certain radio frequency, or a range of radio frequencies around a centre frequency of the cell. The frequency of the cell may belong to a particular frequency band, such as for example Frequency Range 1 (FR1, for example 450 MHz to 6 GHZ) or Frequency Range 2 (FR2, for example 24.25 GHz to 52.6 GHz), for example as specified by 3GPP. In general, a frequency band may comprise a set of predefined radio frequencies, for example a continuous set of frequencies between lower and upper limits of the frequency band.

Communication network 100 may be operated based on a protocol stack comprising a plurality of protocol layers. The protocol stack may be arranged based on the open systems interconnection (OSI) model or a layer model of a particular standard. In one example, the protocol stack may comprise a service data adaptation protocol (SDAP) layer, which may receive data from an application layer for transmission. The SDAP layer may be configured to exchange data with the packet data convergence (PDCP) layer. The PDCP layer may be responsible of generation of data bursts comprising one or more data packets, for example based on data obtained from the SDAP layer.

The PDCP layer may provide data to one or more instances of the radio link control (RLC) layer. For example, PDCP data may be transmitted on one or more RLC transmission legs. Each RLC instance may be associated with corresponding MAC instances of the MAC layer. The MAC layer may provide a mapping between logical channels of upper layer(s) and transport channels of the physical layer, handle multiplexing and demultiplexing of MAC service data units (SDU). Furthermore, the MAC layer may provide error correction functionality based on packet retransmissions, for example according to the hybrid automatic repeat request (HARQ) process. Physically separate transmission legs may be provided by the physical (PHY) layer, also known as Layer 1 (L1). Corresponding protocol stacks may be applied both at access nodes 120, 122, 124 and UE 110.

In a split access node architecture, part of the protocol layers may be implemented at a central unit (CU) of an access node, e.g., a gNB-CU, which may be configured to handle upper layers of the protocol stack, for example SDAP and PDCP layers. Furthermore, gNB-CU may be configured to handle radio resource control (RRC) operations. A central unit of an access node may be associated with, e.g., configured to control, one or more distributed units (DU) of the access node, e.g., gNB-DU, which may be configured to handle lower layers of the protocol stack, for example RLC, MAC, and L1. Radio unit(s) of the gNB-DU(s) may be configured to transmit/receive data to/from UE(s) over the radio interface.

Radio resource control (RRC) of UE 110 may be implemented based on different RRC states, alternatively referred to as RRC modes. When UE 110 is powered up, it may be in a disconnected state or an idle state (e.g., RRC_IDLE). UE 110 may move to a connected state (e.g. RRC_CONNECTED) for example through connection establishment to the network. When UE 110 is in the connected state, signaling radio bearer(s) may be configured to enable exchange of RRC data between UE 110 and the network. If UE 110 is not active for a certain time, UE 110 may move from the connected state to an inactive state (e.g. RRC_INACTIVE).

In the idle state UE 110 may not be associated with an RRC context. From the network point of view there may not be a connection between the radio access network and core network 140 for UE 110. Therefore, UE 110 may not be able to communicate application data with the network. UE 110 may be also in a sleep-mode and only intermittently wake-up, for example for receiving paging messages. UE 110 may however perform cell re-selection and other idle state operations.

In the connected state, UE 110 may be associated with an RRC context. In the connected state, UE 110 may communicate with core network 140 via the radio access network, for example access node 120. The RRC context may comprise parameters configured to enable UE 110 and the network, e.g., access node 120, to communicate RRC data. In the connected state, the UE 110 may perform radio resource management (RRM) measurements, for example in relation to a mobility (handover) procedure. UE 110 may report its measurement results to the network (e.g. via access node 120), for example periodically and/or in response to detecting a reporting triggering criterion to be fulfilled.

In the inactive state, UE 110 may stay registered to the network, but the connection to the radio access network may be suspended. However, the radio access network may store the UE context, which enables the connection to be quickly resumed. The UE context may comprise parameters configured to enable UE 110 and the network, e.g., access node 120, to communicate user plane data (e.g., application data). Connection to the core network may be maintained. Even though particular states such as RRC_CONNECTED, RRC_INACTIVE, or RRC_IDLE are used as examples, it is understood that references to such states may generally refer to connected, inactive, or idle states having characteristics similar to these particular states.

During idle mode operation UE 110 may be configured to look for a suitable cell, for example on a particular public land mobile network (PLMN), select that cell for providing available services, and tune to its control channel. The procedure of selecting the cell and preparing for listening its control channel may be referred to as camping on the cell. For example, during this process UE 110 may register its presence in a registration area of the selected cell, for example by a location registration procedure. If UE 110 subsequently finds a more suitable cell, it may reselect the alternative cell and camp on that cell. When UE 110 has camped on a cell, UE 110 may be enabled to receive system information from the associated PLMN, for example as one or more system information block (SIB) messages. When registered and wishing to initiate a call, UE 110 may initially access the network on the control channel of the cell on which UE 110 is camped. If the PLMN receives user data for the registered UE 110, the network is generally aware of the registration area of the cell on which the registered UE 110 is camped. The network may then send a paging message for UE 110 on control channels of the cells in the registration area. UE 110 may receive the paging message because it may be configured to tune to the control channel of the camped cell in that registration area. Camping on a cell further enables UE 110 to receive cell broadcast messages. When UE 110 has camped on a cell, UE 110 may have completed the cell selection/reselection process and may have chosen a cell. When camped on a cell, UE 110 may be configured to monitor system information and optionally also paging information on the camped cell.

Communication network 100 may comprise other network function(s), network device(s), or protocol(s), in addition, or alternative to, those illustrated in FIG. 1. A network device may be configured to implement functionality of one or more network functions. Even though some embodiments have been described in the context of 5G, it is appreciated that embodiments of the present disclosure are not limited to this example network. Example embodiments may be therefore applied in any present or future communication networks. An apparatus, such as for example UE 110 or access node 120, may comprise, or be configured to implement, e.g. by means of software, one or more of the protocol layers described herein. Example embodiments of the present disclosure may be targeted for example for the following enhancements:

Power saving/energy efficiency enhancements: For example, enhanced eDRX (extended discontinuous reception) in RRC_INACTIVE (e.g., >10.24 s).

Complexity/cost reduction: For example, reduced UE complexity in FR1:
UE baseband (BB) bandwidth reduction: For example, 5 MHz BB bandwidth for PDSCH (e.g., for both unicast and broadcast) and PUSCH, for example with 20 MHz radio frequency (RF) bandwidth for uplink (UL) and downlink (DL). Other physical channels and signals may be configured to use a bandwidth part (BWP) up to the 20 MHz combined maximum of UE RF and BB bandwidth. Support for additional separate early indication(s).
UE peak data rate reduction: For example, relaxation of the constraints (v_{Layers}·Qₘ·f≥4) for peak data rate reduction, where v_{Layers} is the number of MIMO layers, Qₘ is the modulation order (e.g., number of bits per constellation symbol), and f is a scaling factor, e.g., as defined in 3GPP TS 38.306. The relaxed constraint may be for example equal to one (e.g., instead of four). Both 15 kHz and 30 kHz subcarrier spacing may be supported.

Furthermore, the example embodiments of the present disclosure enable coexistence of RedCap and non-RedCap devices and support applicable duplex modes.

As noted above, a RedCap UE has reduced capabilities, for example with the intention of having lower complexity with respect to non-RedCap UEs. A RedCap UE may be configured to support a 20 MHz maximum UE channel bandwidth in FR1. A RedCap UE may be configured to support 100 MHz maximum UE channel bandwidth in FR2. An eRedCap UE (enhanced reduced capability UE) may be a UE that has further reduced capabilities, for example with the intention of having lower complexity with respect to RedCap UEs. An eRedCap UE may be configured to support reduced DL/UL peak data rate of 10 Mbps, with or without reduced baseband bandwidth of 5 MHz for unicast PDSCH/PUSCH in FR1. In general, a RedCap or eRedCap device may be configured to support a first maximum channel bandwidth at a first frequency band and a second maximum channel bandwidth at a second frequency band. The second maximum channel bandwidth may be higher than the first maximum channel bandwidth. The second frequency band may be higher than the first frequency band. A UE, e.g., an (e) RedCap UE, may be however configured to support more than two frequency bands and more than two channel bandwidths. An (e) RedCap device may comprise a 3GPP (e) RedCap device.

Capabilities of RedCap devices, which may also include the category of eRedCap devices, may have reduced (e.g., non-existent) capabilities with respect to one or more of the following: carrier aggregation (CA), multi-RAT (radio access technology) dual-connectivity (MR-DC), dual active protocol stack (DAPS), conditional PSCell (primary secondary cell) addition, conditional PSCell change, or integrated access and backhaul (IAB). Other limitations may however exist. The network (e.g., access node 120) may be configured to prevent RedCap UEs from using radio capabilities not intended for them.

The network (e.g., access node 120) may be configured to identify a RedCap UE during the random access procedure, for example via MSG3/MSGA from RedCap specific logical channel IDs (LCID(s)) or via MSG1/MSGA (e.g., physical random access channel (PRACH) occasion or PRACH preamble. The network (e.g., access node 120) may be configured to identify an eRedCap UE during the random access procedure, for example via MSG3/MSGA from eRedCap specific LCID(s) or via MSG1. For RedCap UE identification via MSG1/MSGA, RedCap specific random access configuration may be configured by the network. For eRedCap UE identification via MSG1, eRedCap specific random access configuration may be configured by the network. For MSG3/MSGA, an (e) RedCap UE may be identified by the network based on dedicated LCID(s) indicated for common control channel (CCCH) identification, for example regardless of whether (e) RedCap specific random access configuration is configured by the network.

Regarding the number of receiver (Rx) branches supported by the UE, (e) RedCap UEs with a single Rx (1 Rx) branch and dual Rx (2 Rx) branches may be allowed separately via system information. Supporting 1 Rx or 2 Rx branches may refer to the UE being capable of, or configured to, operate with 1 Rx or 2 Rx branches, respectively, for example on a particular frequency band. Regarding the duplex mode, (e) RedCap UEs in half-duplex frequency-division duplexing (FDD) mode may be allowed via system information. Allowing UE 110, representing herein a RedCap UE, via system information may comprise indicating by the network, e.g., access node 120, to UE 110 that it is allowed to access the network, e.g., a particular cell which is not barred for UE 110. A device supporting single Rx branch operation on a frequency band may be configured to support one, and not more than one, Rx branch operation at the frequency band. A device supporting dual Rx branch operation on a frequency band may be configured to support operation with at least two Rx branches at the frequency band.

A RedCap specific intra frequency reselection indication (IFRI) may be provided to UE 110, for example in a system information block (SIB) type one (SIB1) message to indicate allowance of UE 110. Based on absence of such indication UE 110 may determine that access is not allowed. Similarly, an eRedCap specific IFRI may be provided in SIB1. And when absent, access may not be allowed for eRedCap UEs. Information on which frequencies (e) RedCap UE access is allowed may be provided in system information. An (e) RedCap UE with 1 Rx branch may be configured to apply an associated offset for broadcasted cell specific reference signal received power (RSRP) thresholds for random access, small data transmission (SDT), cell edge condition and cell (re) selection criterion, for example as specified in 3GPP TS 38.133. The network (e.g., access node 120 may be configured to avoid handover attempts of an (e) RedCap UE to a target cell not supporting (e) RedCap devices. An (e) RedCap UE may be configured with UE implementation specific means for recovering from handover attempts to a target cell that does not support (e) RedCap UEs.

Regarding radio resource management (RRM), RRM measurement relaxation for a RedCap UE may be configured to be enabled or disabled by the network. In RRC_IDLE and RRC_INACTIVE an (e) RedCap UE may be allowed to relax neighbour cell RRM measurements, for example in response to determining the stationary criterion (e.g., the UE being stationary) to be met, or in response to determining both the stationary criterion and a not-at-cell-edge criterion to be met. The network may configure the stationary criterion for an (e) RedCap UE, for example during the RRC_CONNECTED mode. The (e) RedCap UE may report its RRM measurement relaxation fulfilment status to the network, for example using UE assistance information when the stationarity criterion is met or no longer met.

Regarding bandwidth part (BWP) operation, an (e) RedCap UE in RRC_IDLE or RRC_INACTIVE may be configured to monitor paging in an initial BWP (and not other BWPs), (e.g., a default BWP or an (e) RedCap specific BWP), which may be associated with a cell defining synchronization signal block (CD-SSB). The (e) RedCap UE may be configured to perform cell (re-)selection (e.g., related measurements) on the CD-SSB. If a RedCap-specific initial UL BWP is configured and normal uplink (NUL) is selected, (e) RedCap UEs may be configured to use the RedCap-specific initial UL BWP (and not other BWPs) to perform RACH procedure in RRC_IDLE and RRC_INACTIVE or to perform a configured grant (CG) small data transmission (SDT) procedure in RRC_INACTIVE.

An (e) RedCap UE may be configured with multiple non-cell defining (NCD) SSBs, for example when each BWP is configured with at most one SSB. NCD-SSB may be configured for an (e) RedCap UE, e.g., when the UE is in RRC_CONNECTED state, for example to perform radio link monitoring (RLM), bidirectional forwarding detection (BFD), RRM measurements, or random access resource selection when an active BWP does not contain CD-SSB.

An (e) RedCap UE may be configured with NCD-SSB for an (e) RedCap-specific initial downlink BWP, for example for performing SDT procedure in RRC_INACTIVE state, for example in case the (e) RedCap-specific initial downlink BWP does not contain CD-SSB.

As noted above, (e) RedCap UEs with 1 Rx branch and 2 Rx branches may be allowed separately via system information, for example based on example operation(s) of the following procedure configured to be performed by a UE:
1> if the UE is a RedCap UE and it is in RRC_IDLE or in RRC_INACTIVE, or if the RedCap UE is in RRC_CONNECTED while timer T311 is running:
   2> if intraFreqReselectionRedCap is not present in SIB1:
      3> consider the cell as barred, e.g., in accordance with 3GPP TS 38.304;
      3> perform barring as if intraFreqReselectionRedCap is set to allowed;
   2> else:
      3> if the cellBarredRedCap1Rx is present in the acquired SIB1 and is set to barred and the UE is equipped with 1 Rx branch; or
      3> if the cellBarredRedCap2Rx is present in the acquired SIB1 and is set to barred and the UE is equipped with 2 Rx branches; or
      3> if the halfDuplexRedCapAllowed is not present in the acquired SIB1 and the UE supports only half-duplex FDD operation:
         4> consider the cell as barred, e.g., in accordance with 3GPP TS 38.304;
         4> perform barring based on intraFreqReselectionRedCap, e.g., as specified in 3GPP TS 38.304;
1> if the UE is an eRedCap UE and it is in RRC_IDLE or in RRC_INACTIVE, or if the eRedCap UE is in RRC_CONNECTED while T311 is running:
   2> if intraFreqReselection-eRedCap is not present in SIB1:
      3> consider the cell as barred, e.g., in accordance with 3GPP TS 38.304;
      3> perform barring as if intraFreqReselection-eRedCap is set to allowed upon which the procedure ends;
   2> else:
      3> if the cellBarred-eRedCap1Rx is present in the acquired SIB1 and is set to barred and the UE is equipped with 1 Rx branch; or
      3> if the cellBarred-eRedCap2Rx is present in the acquired SIB1 and is set to barred and the UE is equipped with 2 Rx branches; or
      3> if the halfDuplexRedCapAllowed is not present in the acquired SIB1 and the UE supports only half-duplex FDD operation:
         4> consider the cell as barred, e.g., in accordance with 3GPP TS 38.304;
         4> perform barring based on intraFreqReselection-eRedCap, e.g., as specified in 3GPP TS 38.304, upon which the procedure ends.

Timer T311 is used in this example to represent an RRC connection re-establishment timer. T311 may be initialized by UE 110 upon initiating the RRC connection re-establishment procedure. T311 may be stopped by UE 110 upon selection of a suitable cell, e.g., 5G NR cell, or a cell of another RAT. Upon expiry of T311, UE 110 may be configured to enter RRC_IDLE mode.

Field intraFreqReselectionRedCap may comprise an indication of whether intra-frequency cell reselection is allowed for a Redcap UE or not, for example based on values ‘allowed’ or ‘not allowed’. UE 110 may be configured to exclude the barred cell as a candidate for cell selection/reselection, for example for a predetermined time such as 300 seconds, in response to determining that intraFreqReselectionRedCap, e.g., as received in SIB1 message, is set to ‘allowed’. In this case, UE 110 may be configured to select another cell on the same frequency, in response to determining that re-selection criteria are fulfilled.

If the field intraFreqReselectionRedCap is set to ‘not allowed’, UE 110 may be configured to determine whether the cell operates in licensed spectrum, or whether the cell belongs to a public land mobile network (PLMN) which is indicated as being equivalent to the registered PLMN or the selected PLMN of the UE, or whether the cell belongs to the registered standalone non-public network (SNPN) or the selected SNPN of UE 110. If any of these criteria is determined to be met, UE 110 may determine not to re-select to another cell on the same frequency as the barred cell and exclude such cell(s) as candidate(s) for cell selection/reselection, for example for a predetermined time such as 300 seconds. If none of the above criteria is met, UE 110 may select to another cell on the same frequency if reselection criteria are fulfilled. UE 110 may exclude the barred cell as a candidate for cell selection/reselection, for example for a predetermined time such as 300 seconds. The cell selection of another cell may also include a change of RAT.

Field cellBarred-eRedCap1Rx may comprise an indication of whether the cell is barred for an eRedCap UE having one Rx branch. Value ‘barred’ may indicate that the cell is barred for an eRedCap UE with one Rx branch, e.g., as defined in 3GPP TS 38.304. This field may be ignored by non-eRedCap UEs.

Field cellBarred-eRedCap2Rx may comprise an indication of whether the cell is barred for an eRedCap UE having two Rx branches. Value ‘barred’ may indicate that the cell is barred for an eRedCap UE with two Rx branches, e.g., as defined in 3GPP TS 38.304. This field may be ignored by non-eRedCap UEs.

Field cellBarred-RedCap1Rx may comprise an indication of whether the cell is barred for a RedCap UE having one Rx branch. Value ‘barred’ may indicate that the cell is barred for a RedCap UE with one Rx branch, e.g., as defined in 3GPP TS 38.304. This field may be ignored by non-RedCap UEs.

Field cellBarred-RedCap2Rx may comprise an indication of whether the cell is barred for a RedCap UE having two Rx branches. Value ‘barred’ may indicate that the cell is barred for a RedCap UE with two Rx branches, e.g., as defined in 3GPP TS 38.304. This field may be ignored by non-RedCap UEs.

Value ‘not barred’ may indicate that the cell is not barred for devices having the capabilities defined by the respective field.

A cell may be therefore barred for a UE, e.g., (e) RedCap UE, which is equipped with 1 Rx or 2 Rx branches. UE 110 might however support 2 Rx operation on some frequency band and support 1 Rx operation on some other frequency band. In other words, UE 110 might be equipped with 1 Rx and/or 2 Rx branches, but it might be able to use both Rx branches only on certain frequency band(s). Therefore, behaviour of UE 110 may not be clear, if it is intended to determine whether a cell is barred based on whether UE 110 is equipped with 1 Rx or 2 Rx. For example, if 1 Rx is barred and 2 Rx is not barred in the cell, UE 110, equipped with both 1 Rx and 2 Rx capability might either determine in such a case that the cell is always barred or never determine the cell to be barred (e.g., regardless of how UE 110 supports the 1 Rx/2 Rx operation in that particular cell). Example embodiments of the present disclosure improve cell barring for example by enabling UE 110 to consider its capabilities at the relevant frequency band, when determining whether a cell is barred for UE 110 or not.

FIG. 2 illustrates an example of an apparatus configured to practice one or more example embodiments. Apparatus 200 may be a device such as UE 110, or an access node 120, 122, 124, an access point, a base station, a radio network node, or a split portion thereof (e.g., a central or distributed unit of an access node), a network device, a terminal device, or in general any apparatus configured to implement functionality described herein. Apparatus 200 may comprise at least one processor 202. The at least one processor 202 may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

Apparatus 200 may further comprise at least one memory 204. The memory 204 may be configured to store, for example, computer program code 206 or the like, for example operating system software and application software. Memory 204 may comprise one or more volatile memory devices, one or more non-volatile memory devices, and/or a combination thereof. For example, the memory may be embodied as magnetic storage devices (such as hard disk drives, magnetic tapes, etc.), optical magnetic storage devices, or semiconductor memories (such as mask ROM, PROM (programmable ROM), EPROM (erasable PROM), flash ROM, RAM (random access memory), etc.). Memory 204 is provided as an example of a (non-transitory) computer readable medium. The term “non-transitory,” as used herein, is a limitation of the medium itself (i.e., tangible, not a signal) as opposed to a limitation on data storage persistency (e.g., RAM vs. ROM).

Apparatus 200 may further comprise a communication interface 208 configured to enable apparatus 200 to transmit and/or receive information. Communication interface 208 may comprise an external communication interface, such as for example a radio interface between UE 110 and access node(s) 120, 122, 124, or a communication interface between a central unit and distributed unit(s) of an access node (e.g., an F1-U and/or F1-C interface). Communication interface 208 may comprise one or more radio transmitters or receivers, which may be coupled to one or more antennas or apparatus 200, or be configured to be coupled to one or more antennas external to apparatus 200.

Apparatus 200 may further comprise other components and/or functions such as user interface 210 comprising at least one input device and/or at least one output device. The input device may take various forms such a keyboard, a touch screen, or one or more embedded control buttons. The output device may for example comprise a display, a speaker, or the like.

When apparatus 200 is configured to implement some functionality, some component and/or components of apparatus 200, such as for example the at least one processor 202 and/or the at least one memory 204, may be configured to implement this functionality. Furthermore, when the at least one processor 202 is configured to implement some functionality, this functionality may be implemented using program code 206 comprised, for example, in the at least one memory 204.

The functionality described herein may be performed, at least in part, by one or more computer program product components such as software components. According to an example embodiment, apparatus 200 comprises a processor or processor circuitry, such as for example a microcontroller, configured by the program code 206, when executed, to execute the embodiments of the operations and functionality described herein. Program code 206 is provided as an example of instructions which, when executed by the at least one processor 202, cause performance of apparatus 200.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), graphics processing units (GPUs), or the like.

Apparatus 200 may be configured to perform, or cause performance of, method(s) described herein or comprise means for performing method(s) described herein. In one example, the means comprises the at least one processor 202, the at least one memory 204 including instructions (e.g., program code 206) configured to, when executed by the at least one processor 202, cause apparatus 200 to perform the method(s). In general, computer program instructions may be executed on means providing generic processing functions. Such means may be embedded for example in a personal computer, a smart phone, a network device, or the like. The method(s) may be thus computer-implemented, for example based algorithm(s) executable by the generic processing functions, an example of which is the at least one processor 202. The means may comprise transmission or reception means, for example one or more radio transmitters or receivers, which may be coupled or be configured to be coupled to one or more antennas. Apparatus 200 may comprise, for example, a network device, for example, an access node, an access point, a base station, or a central/distributed unit thereof. Although apparatus 200 is illustrated as a single device, it is appreciated that, wherever applicable, functions of apparatus 200 may be distributed to a plurality of devices.

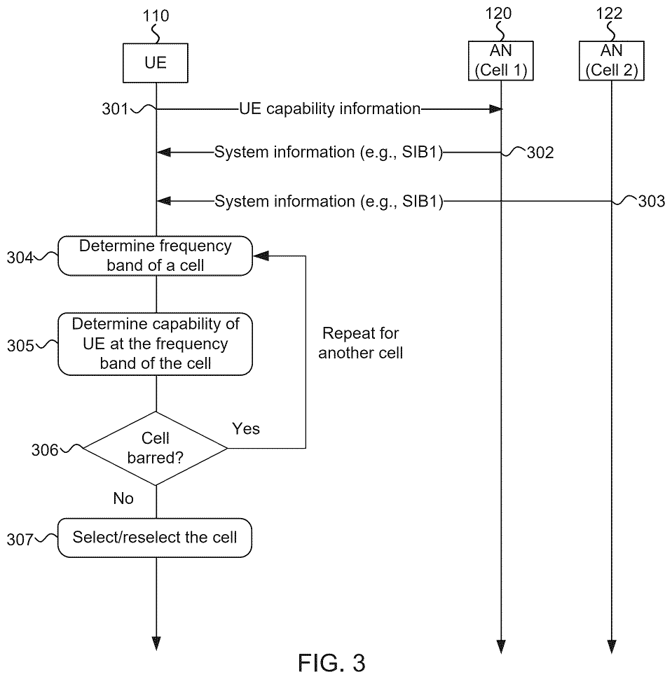

FIG. 3 illustrates an example of signalling and operations for cell barring based on receiver capability of a user equipment (UE) on a certain frequency band.

At operation 301, UE 110 may transmit UE capability information to access node 120. UE capability signalling may be implemented as part of RRC signaling and may enable UE 110 to inform the network about its capabilities to the network, for example access node 120 via Cell 1. UE 110 may transmit the UE capability information in response to a UE capability enquiry received from access node 120 (not illustrated in FIG. 3). UE capability information may comprise various parameters, for example associated with communication capabilities of UE 110.

An example of such a parameter is the maximum number of downlink MIMO (multiple input multiple output) layers, which may indicate the maximum number of downlink MIMO layers configured at UE 110 or supported by UE 110 in Cell 1, for example for the PDSCH. UE 110 may be for example configured to indicate the number of maximum number of downlink MIMO layers by a value of a respective parameter (e.g., maxNumberMIMO-LayersPDSCH), or absence of this parameter, in the UE capability information.

The maximum number of downlink MIMO layers may be dependent on the frequency band of Cell 1. For example, UE 110 might be configured with a 1 Rx branch for a first frequency band (e.g., belonging to FR1) and 2 Rx branches for a second frequency band (e.g., belonging to FR2). UE 110 may be configured to determine the maximum number of downlink MIMO layers based on the frequency band of Cell 1. UE 110 may be for example preconfigured with information about the number of Rx branches supported at different frequency bands. UE 110 may determine the frequency band, or the maximum number of downlink MIMO layers or the number of supported Rx branches directly, based on the frequency of Cell 1.

Note that cell barring may be also implemented without transferring UE capabilities to the network and therefore operation 301 may be optional. Alternatively, the UE capabilities may be transferred during a previous connection (e.g., RRC connection) when UE is in RRC connected state, stored by the network, or transferred after cell (re) selection when UE is in RRC connected state. Therefore, the RRC connection may, in some example embodiments, be released after operation 301. Operations 302 to 307 may be performed during idle, inactive, or connected mode, for example when timer T311, e.g., (RRC) connection re-establishment timer, is running. Generally, the inactive mode procedures of UE 110 may be almost the same as in idle mode, including for example cell (re) selection and cell barring.

At operation 302, UE 110 may receive system information from access node 120. The system information may comprise various parameters and configurations for enabling UE 110 to communicate with the network. The system information may comprise information associate with Cell and/or other cell(s). The system information may comprise a master information block (MIB) and one or more system information blocks (SIB), such as for example SIB1, SIB2, SIB3, SIB4, etc., which may be also referred to as SIB messages. The MIB and SIB1 may be configured to carry information for enabling initial access at Cell 1 and receiving other SIBs. UE 110 may be configured to decode the MIB and SIB1 in order to camp on the Cell 1.

SIB1 may comprise one or more of the following: cell selection information, barring information, (e) RedCap device configuration, a frequency band list, PLMN list, cell identifier of the cell, a tracking area code, a RAN area code, a cell reserved flag, connection establishment failure control information, system information scheduling information, serving cell's common uplink and downlink configuration (e.g., for random access channel or paging), supplementary uplink configuration, synchronization signal block (SSB) scheduling information, cell-specific time domain duplex (TDD) UL/DL configuration, IMS (internet protocol multimedia subsystem) emergency bearer support flag of the cell, emergency call over IMS support flag, timer(s) and constant(s) for the UE, or access control information.

The barring information may comprise an indication of the barring status of the cell, e.g., an indication of whether the cell is barred for UEs having particular capability or capabilities, for example the capability of supporting 1 Rx branch operation or the capability of supporting 2 Rx branch operation. The barring status may be therefore associated with at least one capability of a UE. The indication of the barring status may be associated with the current frequency band. For example, an indirect association via the cell may exists. In this case, the indication of the barring status, or the barring status itself, may be associated with the cell, which may be associated with the current frequency band. Even though in this example the barring status is included in SIB1, UE 110 may, in general, receive the barring status in any suitable control signal or message, examples of which include any SIB messages.

In case the indication of barring status is targeted to (e) RedCap UEs, such indication(s) may be provided for example by parameters cellBarredRedCap1Rx, cellBarredRedCap1Rx, cellBarredeRedCap1Rx, or cellBarredeRedCap1Rx. Directing the indication of the barring status to a category of devices may comprise configuring the indication such that it is applicable to that category of devices, for example applicable to (e) RedCap UEs but not applicable to non-(e) RedCap UEs. Non-(e) RedCap UEs may therefore ignore the indication of the barring status. It is however noted that example embodiments of the present disclosure may be also applied to UE capabilities of any type of UE, e.g., regardless of whether they belong to a category of reduced capability devices or not.

SIB2 may comprise one or more of the following: cell reselection information, cell reselection serving frequency information, or intra-frequency cell reselection information, such as for example a frequency band list.

SIB3 may comprise information about the serving frequency and intra-frequency neighbouring cells relevant for cell re-selection, for example cell re-selection parameters common for a frequency and/or cell-specific re-selection parameters. SIB3 may for example comprise intra-frequency neighbour cell information, such as intra-frequency neighbouring cell list information (e.g., IntraFreqNeighCellInfo), comprising for example cell identifiers (e.g., physCellId) of the neighbouring intra-frequency cells. For example, SIB3 received by UE 110 at Cell 1 from access node 120 might comprise cell identifier of Cell 2 as an intra-frequency neighbour cell.

SIB4 may comprise information about frequencies of the same RAT (e.g., 5G NR) and/or inter-frequency neighbouring cells relevant for cell re-selection, for example cell re-selection parameters common for a frequency and/or cell specific re-selection parameters. SIB4 may for example comprise inter-frequency neighbour cell information, such as inter-frequency carrier frequency list information (e.g., interFreqCarrierFreqList), comprising for example downlink carrier frequencies or inter-frequency neighbour cells, a frequency band list (e.g., frequencyBandList), or the like. For example, SIB4 received by UE 110 at Cell 1 from access node 120 might comprise an indication of the frequency of Cell 2 as an inter-frequency neighbour cell. Other SIBs may include further signalling information. The SIBs may be transmitted over the downlink shared channel (DL-SCH) transport channel, which may be carrier on the PDSCH.

At operation 303, UE 110 may receive system information of Cell 2 from access node 122, for example the MIB and/or one or more SIBs as described above. In this case, the system information may generally comprise information specific to Cell 2. However, in this case SIB3 might comprise cell identifier of Cell 1 as an intra-frequency neighbour cell or SIB4 might comprise an indication of the frequency of Cell 1 as an inter-frequency neighbour cell.

It is noted that further operations of the procedure of FIG. 3 may be performed by UE 110 based the system information received from Cell 1, Cell 2, or both. Accordingly, operations 301 and 302 may be mutually optional, but in some example embodiments UE 110 may be configured to perform both operations. Receiving the system information may comprise extracting and decoding the system information, for example from one or more SIBs from a downlink signal (e.g., PDSCH).

At operation 304, UE 110 may determine the frequency band of a cell. The cell in question may be a cell on which UE 110 is intending to camp. Cell 1 is used herein as an example of such a cell. UE 110 may therefore determine the frequency band of Cell 1, for example based on the carrier frequency of Cell 1 (e.g., as indicated in system information). UE 110 may for example determine whether the carrier frequency of Cell 1 belongs to FR1, FR2, or another frequency band. UE 110 may determine the frequency band of Cell 1 based on the system information received from Cell 1, Cell 2, or another cell, for example based on the frequency band list received in a SIB (e.g., SIB2 or SIB4).

For example, UE 110 may determine the frequency band where UE 110 currently is, e.g., the current frequency band of UE 110, based on the frequency band of the cell on which UE 110 intends to camp (e.g., Cell 1) or based on the frequency band of the cell from which it has received the barring information (e.g., Cell 2). Alternatively, or additionally, UE 110 may determine the frequency band where UE 110 currently is based on the frequency band list received via the system information (e.g., SIB(s)). The frequency band list may comprise a list of one or multiple frequency bands to which these carrier(s) belong.

At operation 305, UE 110 may determine a capability of UE 110 at the frequency band of Cell 1 (cf., the frequency band on which UE 110 currently is). For example, UE 110 may consider its capabilities at the frequency band determined at operation 304 and determine its capability on that frequency band accordingly. The determination of the UE capability may be therefore based on the frequency band determined at operation 304. This provides the benefit of improving cell barring configuration by enabling to consider different capabilities of UE 110 at different frequency bands. UE 110 is therefore enabled to take into account its capabilities at the current frequency band, when determining whether a cell is barred or not, thereby for example enabling deterministic behaviour of UE 110.

The capability of UE 110 may be related to receiver operation of UE 110. The capability of UE 110 may for example indicate whether UE 110 supports, e.g., is able to use or is configured to use, 1 Rx branch operation or 2 Rx branch operation at the frequency band of Cell 1. As noted above, this improves configuration of cell barring. For example, without considering the frequency band specific capabilities regarding the support for 1 Rx or 2 Rx branch operation, UE 110 might be limited to use information on whether UE 110 is equipped with one or two receiver branches when determining whether a cell is barred, rather than whether UE 110 is able or configured to apply two receiver branches at a particular frequency band.

UE 110 may determine its capability to support 1Rx branch operation or 2Rx branch operation based its downlink MIMO capability at the frequency band of Cell 1, for example based on the maximum number of downlink MIMO layers supported at the frequency band of Cell 1. This provides the benefit of obtaining information on the 1 Rx or 2 Rx branch capability of UE 110 without separately storing such information at UE 110. UE 110 may determine its capability to support 1Rx or 2Rx branch operation based on the value of the maximum number of downlink MIMO layers, or absence of this parameter, in the UE capability information of UE 110 for the current frequency band (cf., frequency band of Cell 1). For example, UE 110 may determine that it has the capability to support 1Rx branch operation at the frequency band of Cell 1 based on absence of the indication of the maximum number of downlink MIMO layers in the UE capability provided to Cell 1. Alternatively, UE 110 may determine that it has the capability to support 2Rx branch operation, if the maximum number of downlink MIMO layers in the UE capability information indicates two downlink MIMO layers (e.g., by setting the value of maxNumberMIMO-LayersPDSCH to twoLayers) for the current frequency band. The UE capability information configured to indicate the maximum number of downlink MIMO layers may be associated with Cell 1 and therefore the current frequency band of Cell 1.

UE 110 may determine its capability to support 1Rx branch operation or 2Rx branch operation based the frequency band of Cell 1 belonging to a particular frequency range, such as for example FR1 or FR2. For example, UE 110 may determine that it has the capability to support 2Rx branch operation, in response to determining that the frequency band of Cell 1 belongs to FR2. UE 110 may determine this based on a preconfigured mapping between the frequency bands or ranges to the number of receiver branches supported on respective frequency bands or ranges.

At operation 306, UE 110 may determine whether Cell 1 is barred for UE 110. UE 110 may determine whether Cell 1 is barred for UE 110 based on the barring status of Cell 1 (e.g., whether Cell 1 is barred for UEs with a particular capability such as supporting 1Rx or 2Rx branch operation) and the capability of UE 110 at the frequency band of Cell 1 (e.g., whether UE 110 supports 1Rx or 2 Rx branch operation at the frequency band of Cell 1).

For example, UE 110 may determine that Cell 1 is barred for UE 110, in response determining that the barring status, for example as received at operation 302 or 303, indicates Cell 1 to be barred for UEs supporting 1Rx branch operation and that UE 110 supports 1Rx branch operation at the frequency band Cell 1. Alternatively, UE 110 may determine that Cell 1 is barred for UE 110, in response determining that the barring status indicates Cell 1 to be barred for UEs supporting 2Rx branch operation and that UE 110 supports 2Rx branch operation at the frequency band Cell 1.

Furthermore, UE 110 may determine that Cell 1 is not barred for UE 110, in response determining that the barring status indicates Cell 1 not to be barred for UEs supporting 1Rx branch operation and that UE 110 supports 1Rx branch operation at the frequency band Cell 1. Alternatively, UE 110 may determine that Cell 1 is not barred for UE 110, in response determining that the barring status indicates Cell 1 not to be barred for UEs supporting 2Rx branch operation and that UE 110 supports 2Rx branch operation at the frequency band Cell 1.

At operation 307, UE 110 may determine, based on whether Cell 1 is barred for UE 110, whether to select or reselect Cell 1. For example, UE 110 may determine to refrain from selecting or reselecting Cell 1, in response to determining that Cell 1 is barred for UE 110. Refraining from selecting or reselecting a cell may comprise determining not to select or reselect the cell, even if other cell selection or reselection criteria would allow selection or reselection of the cell. If Cell 1 is barred for UE 110, UE 110 may end the procedure or move back to operation 304, in order to consider (cf., operations 305 and 306) whether to select or reselect another cell. Upon initiating a new round of operations 304, 305, and 306, UE 110 may receive system information from any other relevant cells, similar to operation 302 or 303.

UE 110 may determine to select or reselect Cell 1 based on determining that Cell 1 is not barred for UE 110. UE 110 may optionally consider also other criteria (e.g., condition(s) associated with idle/inactive state measurements or configured cell (re) selection criteria) for determining whether to select or reselect Cell 1. UE 110 may determine to select or reselect Cell 1, in response to determining that one or more criteria, including the cell not being barred for UE 110, are fulfilled. If Cell 1 is not barred for UE 110, UE 110 may move to execution of operation 307.

Cell selection may comprise selecting a suitable cell when UE 110 is not camped on any cell. UE 110 may be configured to perform initial cell selection when it has no prior knowledge of available radio frequency (RF) channels for the RAT in question (e.g., 5G NR). UE 110 may for example scan different RF channels in relevant frequency bands according to its capabilities, in order to find a suitable cell. UE 110 may be configured to search for the strongest cell at each carrier frequency. When information on the available carriers, optionally with information on cell parameters, is available, UE 110 may search for suitable cells based on information stored at UE 110. Once a suitable cell is found, UE 110 may select this cell. UE 110 may then camp on the selected cell.

When camped on a cell, UE 110 may be configured to search for a better cell according to cell reselection criteria. If a better cell is found, UE 110 may then select this cell. This procedure may be referred to as cell reselection. The change of cell may include a change of RAT.

Subsequent to selection or reselection of the cell at operation 307, UE 110 may camp on the selected or reselected cell and communicate application data with the network via the selected or reselected cell.

The procedure of FIG. 3 may be implemented for example based one or more operations of the following procedure:
1> if the UE is a RedCap UE and it is in RRC_IDLE or in RRC_INACTIVE, or if the RedCap UE is in RRC_CONNECTED while timer T311 is running:
   2> if intraFreqReselectionRedCap is not present in SIB1:
      3> consider the cell as barred, e.g., in accordance with TS 38.304;
      3> perform barring as if intraFreqReselectionRedCap is set to allowed;
   2> else:
      3> if the cellBarredRedCap1Rx is present in the acquired SIB1 and is set to barred and the UE is supporting 1 Rx operation on the current band; or
      3> if the cellBarredRedCap2Rx is present in the acquired SIB1 and is set to barred and the UE is supporting 2 Rx operation on the current band; or
      3> if the halfDuplexRedCapAllowed is not present in the acquired SIB1 and the UE supports only half-duplex FDD operation:
         4> consider the cell as barred, e.g., in accordance with 3GPP TS 38.304;
         4> perform barring based on intraFreqReselectionRedCap, e.g., as specified in TS 38.304;
1> if the UE is an eRedCap UE and it is in RRC_IDLE or in RRC_INACTIVE, or if the eRedCap UE is in RRC_CONNECTED while T311 is running:
   2> if intraFreqReselection-eRedCap is not present in SIB1:
      3> consider the cell as barred, e.g., in accordance with TS 38.304;
      3> perform barring as if intraFreqReselection-eRedCap is set to allowed upon which the procedure ends;
   2> else:
      3> if the cellBarred-eRedCap1Rx is present in the acquired SIB1 and is set to barred and the UE is supporting 1 Rx operation on the current band; or
      3> if the cellBarred-eRedCap2Rx is present in the acquired SIB1 and is set to barred and the UE is supporting 2 Rx operation on the current band; or
      3> if the halfDuplexRedCapAllowed is not present in the acquired SIB1 and the UE supports only half-duplex FDD operation:
         4> consider the cell as barred, e.g., in accordance with TS 38.304;
         4> perform barring based on intraFreqReselection-eRedCap, e.g., as specified in TS 38.304, upon which the procedure ends.

UE 110 may determine whether cell is barred based on the barring status (e.g., the cell barring indication(s) listed below) and based on the current frequency band.

UE 110 may determine that the cell is not barred if cellBarred-eRedCap1Rx indicates “not barred” and UE 110 is eRedCap UE supporting 1 Rx on the band at which UE 110 currently is.

UE 110 may determine that the cell is not barred if cellBarred-eRedCap2Rx indicates “not barred” and UE 110 is eRedCap UE supporting 2 Rx on the band at which UE 110 currently is.

UE 110 may determine that the cell is not barred if cellBarredRedCap1Rx indicates “not barred” and UE 110 is RedCap UE supporting 1 Rx on the band at which UE 110 currently is.

UE 110 may determine that the cell is not barred if cellBarredRedCap2Rx indicates “not barred” and the UE 110 is RedCap UE supporting 2 Rx on the band at which UE 119 currently is.

UE 110 may determine that the cell is barred if cellBarred-eRedCap1Rx indicates “barred” and UE 110 is eRedCap UE supporting 1 Rx on the band at which UE 110 currently is.

UE 110 may determine that the cell is barred if cellBarred-eRedCap2Rx indicates “barred” and UE 110 is eRedCap UE supporting 2 Rx on the band at which UE 110 currently is.

UE 110 may determine that the cell is barred if cellBarredRedCap1Rx indicates “barred” and UE 110 is RedCap UE supporting 1 Rx on the band at which UE 110 currently is.

UE 110 may determine that the cell is barred if cellBarredRedCap2Rx indicates “barred” and UE 110 is RedCap UE supporting 2 Rx on the band at which UE 110 currently is.

UE 110 may determine that if the cell is barred, the access is not allowed for UE 110 on the cell.

UE 110 may determine that if the cell is not barred, the access is allowed for UE 110 on the cell.

Supporting 1 Rx or 2 Rx may refer to being capable of operating with 1 Rx or 2 Rx.

UE 110 may determine the band, where UE 110 currently is, based on the band where UE 110 is camping on a cell or based on the band of the cell where the abovementioned cell barring indications are received.

UE 110 may determine the band, where UE 110 currently is, based on the frequency band list received via the system information (SIB). The frequency band list may indicate a list of one or multiple frequency bands to which these carrier(s) belong.

UE 110 may determine the support for 1Rx or 2Rx on the current band based on whether UE 110 indicates maxNumberMIMO-LayersPDSCH as absent for the current frequency band or maxNumberMIMO-LayersPDSCH as twoLayers, respectively. UE 110 may determine that it supports 1Rx if maxNumberMIMO-LayersPDSCH is absent.

UE 110 may determine the support for 1Rx or 2Rx on the current frequency band based on the Frequency Range. For example, if the current frequency band belongs to FR2, UE 110 may determine that it supports 2 Rx.

UE 110 may base the determination of the support for 1Rx or 2Rx on the current frequency band on the UE indication of maxNumberMIMO-LayersPDSCH as absent for the current frequency band or maxNumberMIMO-LayersPDSCH as twoLayers in UE capability information, respectively. For example, UE 110 may determine that it supports 2Rx if maxNumberMIMO-LayersPDSCH is set to twoLayers.

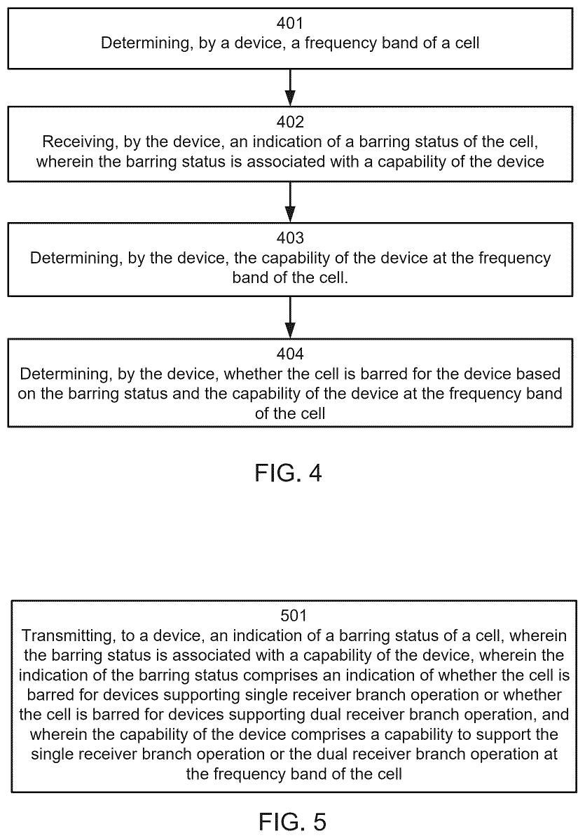

FIG. 4 illustrates an example of a method for cell barring. The method may be performed by a device, e.g., UE 110, or by a control apparatus configured to control the functioning thereof, when installed therein.

At operation 401, the method may comprise determining, by a device, a frequency band of a cell.

At operation 402, the method may comprise receiving, by the device, an indication of a barring status of the cell, wherein the barring status is associated with a capability of the device.

At operation 403, the method may comprise determining, by the device, the capability of the device at the frequency band of the cell.

At operation 404, the method may comprise determining, by the device, whether the cell is barred for the device based on the barring status and the capability of the device at the frequency band of the cell.

FIG. 5 illustrates an example of a method for controlling cell barring. The method may be performed by an access node, or by a control apparatus configured to control the functioning thereof, when installed therein.

At operation 501, the method may comprise transmitting, to a device, an indication of a barring status of a cell, wherein the barring status is associated with a capability of the device, wherein the indication of the barring status comprises an indication of whether the cell is barred for devices supporting 1 Rx branch operation or whether the cell is barred for devices supporting 2 Rx branch operation, and wherein the capability of the device comprises a capability to support the 1 Rx receiver branch operation or the 2 Rx branch operation at the frequency band of the cell.

Further features of the methods directly result for example from functionality of UE 110, access node(s) 120, 122, 124, as described throughout the description, claims, and drawings, and are therefore not repeated here. An apparatus, for example a device such as UE 110, or an access node, may be configured to perform or cause performance of any aspect of the method(s) described herein. Further, a computer program or a computer program product may comprise instructions for causing, when executed by an apparatus, the apparatus to perform any aspect of the method(s) described herein. Further, an apparatus may comprise means for performing any aspect of the method(s) described herein. According to an example embodiment, the means comprises at least one processor; and at least one memory storing instructions that, when executed by the at least one processor, cause the apparatus at least to perform any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. For example, the order of operations 401 and 402 may be changed. This may be the case for example when the indication of the barring is included in in SIB1 and UE 110 is configured to determine the frequency band of the cell based on the frequencyBandList in SIB1. It is also possible that the frequencyBandList, which may be used by UE 110 as basis for determining the frequency band of the cell, and the indication of the barring indications are received at the same time. Therefore, UE 110 may be configured to execute operations 401 and 402 any order, or in parallel. Alternatively, the reception of the indication of the barring status might be performed as a separate step, for example as the first operation of FIG. 4.

Additionally, individual blocks may be deleted from any of the methods without departing from the scope of the subject matter described herein. Aspects of any of the example embodiments described above may be combined with aspects of any of the other example embodiments described to form further example embodiments without losing the effect sought.

The term ‘comprising’ is used herein to mean including the method, blocks, or elements identified, but that such blocks or elements do not comprise an exclusive list and a method or apparatus may contain additional blocks or elements.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. Expression “or” may be understood as a non-exclusive “or” and therefore a list or two or more elements indicated to be mutually optional by the expression “or” means at least any one of the elements, or at least any two or more of the elements, or at least all the elements.

Although subjects may be referred to as ‘first’ or ‘second’ subjects, this does not necessarily indicate any order or importance of the subjects. Instead, such attributes may be used solely for the purpose of making a difference between subjects.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A method, comprising:
determining, by a device, a frequency band of a cell;
receiving, by the device, an indication of a barring status of the cell, wherein the barring status is associated with a capability of the device;
determining, by the device, the capability of the device at the frequency band of the cell; and
determining, by the device, whether the cell is barred for the device based on the barring status and the capability of the device at the frequency band of the cell.

2. A method, comprising:
transmitting, to a device, an indication of a barring status of a cell, wherein the barring status is associated with a capability of the device, wherein the indication of the barring status comprises an indication of whether the cell is barred for devices supporting single receiver branch operation or whether the cell is barred for devices supporting dual receiver branch operation, and wherein the capability of the device comprises a capability to support the single receiver branch operation or the dual receiver branch operation at the frequency band of the cell.

3. An apparatus, comprising:
at least one processor; and
at least one memory storing instructions that, when executed by the at least one processor, cause the apparatus at least to perform:
determining a frequency band of a cell;
receiving an indication of a barring status of the cell, wherein the barring status is associated with a capability of the apparatus;
determining the capability of the apparatus at the frequency band of the cell; and
determining whether the cell is barred for the apparatus based on the barring status and the capability of the apparatus at the frequency band of the cell.

4. The apparatus according to claim 3, wherein the indication of the barring status comprises an indication of whether the cell is barred for devices supporting single receiver branch operation or whether the cell is barred for devices supporting dual receiver branch operation, and wherein the capability of the apparatus comprises a capability to support the single receiver branch operation or the dual receiver branch operation at the frequency band of the cell.

5. The apparatus according to claim 4, further caused to perform:
determining the capability to support the single receiver branch operation or the dual receiver branch operation based on a maximum number of downlink multiple input multiple output (MIMO) layers supported by the apparatus at the frequency band of the cell.

6. The apparatus according to claim 5, further caused to perform:
determining that the apparatus has the capability to support the single receiver branch operation, based on absence of an indication of the maximum number of downlink MIMO layers in user equipment capability information of the apparatus; or
determining that the apparatus has the capability to support the dual receiver branch operation, in response to determining the indication of the maximum number of downlink MIMO layers in the user equipment capability information of the apparatus to indicate two downlink MIMO layers; or
determining that the apparatus has the capability to support the dual receiver branch operation, in response to determining that the frequency band of the cell belongs to a Frequency Range 2.

7. The apparatus according to claim 4, further caused to perform:
determining that the cell is barred for the apparatus, in response determining that the barring status is indicative of the cell being barred for devices supporting the single receiver branch operation and that the apparatus supports the single receiver branch operation at the frequency band of the cell; or
determining that the cell is barred for the apparatus, in response determining that the barring status is indicative of the cell being barred for devices supporting the dual receiver branch operation and that the apparatus supports the dual receiver branch operation at the frequency band of the cell.

8. The apparatus according to claim 4, further caused to perform:
determining that the cell is not barred for the apparatus, in response to determining that the barring status is indicative of the cell not being barred for devices supporting the single receiver branch operation and that the apparatus supports the single receiver branch operation at the frequency band of the cell; or
determining the cell is not barred for the apparatus, in response to determining that the barring status is indicative of the cell not being barred for devices supporting the dual receiver branch operation and that the apparatus supports the dual receiver branch operation at the frequency band of the cell.

9. The apparatus according to claim 3, further caused to perform:
determining to refrain from selecting or reselecting the cell, in response to determining that the cell is barred for the apparatus; or
determining to select or reselect the cell, based on determining that the cell is not barred for the apparatus.

10. The apparatus according to claim 3, wherein the indication of the barring status is targeted to devices belonging to a category of reduced capability devices.

11. The apparatus according to claim 3, wherein the capability of the apparatus comprises the apparatus belonging to a category of reduced capability devices.

12. The apparatus according to claim 3, wherein the apparatus belongs to a category of reduced capability devices.

13. The apparatus according to claim 10, wherein the category of reduced capability devices comprises a category of RedCap devices or a category of eRedCap devices.

14. The apparatus according to claim 3, wherein the indication of the barring status is associated with a current frequency band of the cell, or wherein the capability of the apparatus is related to receiver operation of the apparatus.

15. The apparatus according to claim 3, further caused to perform:
receiving the indication of the barring status from the cell via a system information block message.

16. The apparatus according to claim 15, further caused to perform:
determining the frequency band of the cell based on a frequency band list received from the cell via the system information block message.

17. The apparatus according to claim 3, wherein the apparatus is not allowed to access the cell when the cell is barred for the apparatus.

18. An apparatus, comprising:
at least one processor; and
at least one memory storing instructions that, when executed by the at least one processor, cause the apparatus at least to perform:
transmitting, to a device, an indication of a barring status of a cell, wherein the barring status is associated with a capability of the device, wherein the indication of the barring status comprises an indication of whether the cell is barred for devices supporting single receiver branch operation or whether the cell is barred for devices supporting dual receiver branch operation, and wherein the capability of the device comprises a capability to support the single receiver branch operation or the dual receiver branch operation at the frequency band of the cell.

19. The apparatus according to claim 18, wherein the indication of the barring status is targeted to devices belonging to a category of reduced capability devices.

20. The apparatus according to claim 18, wherein the capability of the device comprises the device belonging to a category of reduced capability devices.

21. The apparatus according to claim 18, wherein the device belongs to a category of reduced capability devices.

22. The apparatus according to claim 18, wherein the category of reduced capability devices comprises a category of RedCap devices or a category of eRedCap devices.

23. The apparatus according to claim 18, wherein the indication of the barring status is associated with a current frequency band of the cell, or wherein the capability of the device is related to receiver operation of the device.
